(19) United States
(12) Patent Application Publication
(10) Pub. No.: US 2008/0065618 A1
(43) Pub. Date: Mar. 13, 2008

(54) INDEXING FOR RAPID DATABASE SEARCHING

(76) Inventor: David A. Maluf, Mountain View, CA (US)

Correspondence Address: Zilka-Kotab, PC, P.O. BOX 721120, SAN JOSE, CA, 95172-1120, US

(21) Appl. No.: 11/459,811

(22) Filed: Jul. 25, 2006

(51) Int. Cl. G06F 17/30

(52) U.S. Cl. 707/5

(57) ABSTRACT

Methods and systems for implementing a rapid search of information items in a database. Each relevant Word (an individual word and/or a phrase including two or more words) in a collection of documents is associated with a location number within the collection, as a Word pair, including a Word and a location number. The Word pairs in the collection are rearranged into consecutive sub-sequences, each sub-sequence including all occurrences of each Word in the collection. For each, sub-sequence, upper and lower bounds are provided to limit the search for a specified Word to a relatively narrow range of location numbers. The approach is extended from single Word occurrences to Boolean occurrences involving two or more Words, using Boolean operators such as OR, AND and XOR.

### FIELD OF THE INVENTION

This invention relates to database indexing and searching.

### BACKGROUND OF THE INVENTION

Full text searching for occurrence of a relevant word and/or phrase in a database consisting of all statements within a single document or all documents within a single class, is time consuming. Full text searching for such occurrence in all documents in a large collection of documents is even more time consuming. This is due, in large measure, to non-adjacency of a relevant word and/or phrase within the document: the relevant word and/or phrase can occur in a few dozen locations that are spaced apart by substantial distances within the document. Further, a straightforward search of an unprocessed document does not permit searching for two or more occurrences of the same word and/or phrase within K words and/or phrases of each other and does not permit simultaneous search for singular and plural versions and inverse versions of a given word and/or phrase. Further, a database index, once established, is difficult to modify by adding or modifying or deleting a group of entries associated with a given document.

What is needed is an approach that provides database indexing that, upon prescription of a word or phrase in context, allows rapid, targeted searching of a small subset of the database that contains the only references that are relevant to the targeted word or phrase. Preferably, the approach should permit relatively straightforward (i) expansion of the subset to include one or more new references and (ii) deletion of a portion of a subset, in response to updating or correcting one or more references in the subset.

### SUMMARY OF THE INVENTION

These needs are met by various embodiments of the present invention. One embodiment includes a method for constructing a database index and for rapid and efficient searching of an identifiable (first) subset of the index to identify all relevant references to a selected word or phrase (collectively referred to as a “Word”). Optionally, a second subset, which is a portion of and is contained in the first subset, is identified to refine and further focus the search.

According to an embodiment of the present invention, an initial vector V0 is formed from the collection of all relevant Words (except the optionally deleted Words). Each occurrence of a relevant Word is paired with a corresponding location number or location index, indicating the location of the Word within the collection and within the document where the particular occurrence(s) of that Word is/are found. An example of the location number is (collection/sub collection/ . . . /file no./byte location) of the corresponding Word. An example is: 00001 (collection indicium)/00005 (folder indicium)/0003 (file indicium)/0040 (byte location). If the vector V0 is stored at any level in the sub-collection or folder, listing the full reference is optional. Where the initial vector V0 is stored with the files themselves, only the file no and byte location are used. A collection of “Word pairs,” each including a Word and a location number or location index for the Word, provides a sorted vector SV. A simple example of a sorted vector is the following:
SV[{Word, collection/subcollection/ . . . /byte position} {Hello, 001/002/003/0200}, {Zebra, 020/004/304}, . . . ]

Each Word and its corresponding location may appear as a Word pair in the sorted vector SV once for each location, and all occurrences of the Word from all documents in the collection will appear in a consecutive segment in the sorted vector SV. That is, if the given Word (e.g., “hello world”) appears 17 times in the collection, the sorted vector SV will contain 17 Word pairs, each pair consisting of the Word (“hello world”) plus the corresponding location number, and these 17 pairs will appear consecutively in SV. The SV may list each Word (the first member of a Word pair) alphabetically, or using some other basis for the listing; all Words should be included (except for articles, connectives, referents, possessives, prepositions, etc, which are optionally deleted from SV), and all occurrences of a given Word should be grouped consecutively. Punctuation (commas, semicolons, etc.) is optionally ignored

A hash function H(n) is generated, corresponding to a monotonic increasing function of location number n that produces a real umber representing the cumulative number C(n) of occurrences of a Word in the sorted vector SV. Use of H(n) is optional for a Word that is an integer, a float, a double precision number, etc. A checksum is applied to the hash function H(n), according to which the resulting numbers generated by H(n) will have the same arrangement (preceding or following) as the Words have been arranged in SV.

Where the sorted vector SV includes a large number of Words, the hash function H(n) will increase monotonically and approximately linearly with the location number n (=1, 2, . . . ), with an approximate straight line slope value μ={H(nₗₐₛₜ}−H(n_{first})}/(nₗₐₛₜ−n_{first}) for each occurrence of the specified Word in SV, where n_{first} and nₗₐₛₜ are the first and last location numbers for the specified Word. The slope value μ and a deviation value, ΔH(n)=H(n;actual)−H(n;linear approx) are used to limit the search range for a specified Word. For a given Word, the deviation value has a maximum magnitude for all location numbers n.

A straight line segment SL, extending from a point with coordinates (n_{first},H(n_{first})) on the graph where the specified Word first occurs, to a point with coordinates (nₗₐₛₜ,H(nₗₐₛₜ)) on the graph where the last occurrence of the specified Word occurs, will have a characteristic slope μ(Word), which is non-negative but may vary from one Word to another Word. A pair of displaced linesegments, SL1 and SL2, one above and one below SL and extending approximately parallel to SL will contain between these two lines all points {(n,H(n))}ₙ on the graph for n_{first}≦n≦nₗₐₛₜ. More generally, the two line segments can be replaced by monotonic functions, F_{U}(n) and F_{L}(n), ling above and below the graph {(n,H(n))}ₙ.

When a specified Word is to be searched, a particular occurrence of that Word (not necessarily the first occurrence) is identified, and the two functions, F_{U}(n) and F_{L}(n), are used to bound, locate and identify all occurrences of the specified Word, in a total search time that is a fraction of the time that would be required for a conventional search for all occurrences of the specified Word.

All words and/or phrases, except the (optionally deleted) articles, connectives, referents, possessives, prepositions and similar non-context words are presented as a sequence of discrete statements, with each statement containing one or more of the relevant words and/or phrases, in a format analogous to a format of a two-dimensional matrix.

### BRIEF DESCRIPTION OF THE DRAWINGS

FIG. 1 graphically illustrates implementation of a first embodiment.

FIG. 2 is a flow chart for practicing an embodiment of the invention.

### DESCRIPTION OF BEST MODES OF THE INVENTION

The following description is the best mode presently contemplated for carrying out the present invention. This description is made for the purpose of illustrating the general principles of the present invention and is not meant to limit the inventive concepts claimed herein. Further, particular features described herein can be used in combination with other described features in each and any of the various possible combinations and permutations.

In particular, various embodiments of the invention discussed below are implemented using the Internet as a means of communicating among a plurality of computer systems. One skilled in the art will recognize that the present invention is not limited to the use of the Internet as a communication medium and that alternative methods of the invention may accommodate the use of a private intranet, a Local Area Network (LAN), a Wide Area Network (WAN) or other means of communication. In addition, various combinations of wired, wireless (e.g., radio frequency) and optical communication links may be utilized.

The program environment in which a present embodiment of the invention is executed illustratively incorporates one or more general-purpose computers or special-purpose devices such hand-held computers. Details of such devices (e.g., processor, memory, data storage, input and output devices) are well known and are omitted for the sake of clarity.

It should also be understood that the techniques of the present invention might be implemented using a variety of technologies. For example, the methods described herein may be implemented in software running on a computer system, or implemented in hardware utilizing either a combination of microprocessors or other specially designed application specific integrated circuits, programmable logic devices, or various combinations thereof. In particular, methods described herein may be implemented by a series of computer-executable instructions residing on a storage medium such as a carrier wave, disk drive, or computer-readable medium. Exemplary forms of carrier waves may be electrical, electromagnetic or optical signals conveying digital data streams along a local network or a publicly accessible network such as the Internet. In addition, although specific embodiments of the invention may employ object-oriented software programming concepts, the invention is not so limited and is easily adapted to employ other forms of directing the operation of a computer.

The invention can also be provided in the form of a computer program product comprising a computer readable medium having computer code thereon. A computer readable medium can include any medium capable of storing computer code thereon for use by a computer, including optical media such as read only and writeable CD and DVD, magnetic memory, semiconductor memory (e.g., FLASH memory and other portable memory cards, etc.), etc. Further, such software can be downloadable or otherwise transferable from one computing device to another via network, wireless link, nonvolatile memory device, etc.

According to one embodiment of the present invention, a vector V0 of Word pairs is formed, including every word or phrase (collectively referred to herein as a “Word” and its corresponding location number or location index n in a document or a collection of documents. The location number may specify title/date/page(s)/line(s) for the Word occurrence, for example. Optionally, all articles (a, an, the, etc.), connectives (and, but, nor, etc.), referents (I, you, we, they, etc.), possessives (my, your, our, their, etc.), prepositions (by, for, of, above, below, etc.) and/or similar non-context words are deleted from the document(s) before the vector V0 is formed, to provide Word pairs of relevant words. For a conventional document, it is estimated that this deletion will remove as many as one-third of the total number of Words from consideration.

A new, sorted vector SV of Word pairs is now formed from the vector V0, in which all Word pairs for a specified Word are grouped together consecutively, in a sub-sequence. The consecutive sub-sequences may be arranged alphabetically, according to the Word, or on some other basis.

For a specified Word, a graph is provided, with numerical location number n (e.g., n=1, 2, . . . ) measured along the abscissa (x-axis) and a hash function H(n) that may correspond to cumulative number of occurrences C(n) of the specified Word (once, twice, three times, four times, etc.), measured along the ordinate (y-axis). That is, the y-axis value will increase by one unit each time the specified Word occurs within the document or collection, and this increase will occur at the location number at which the specified Word occurs.

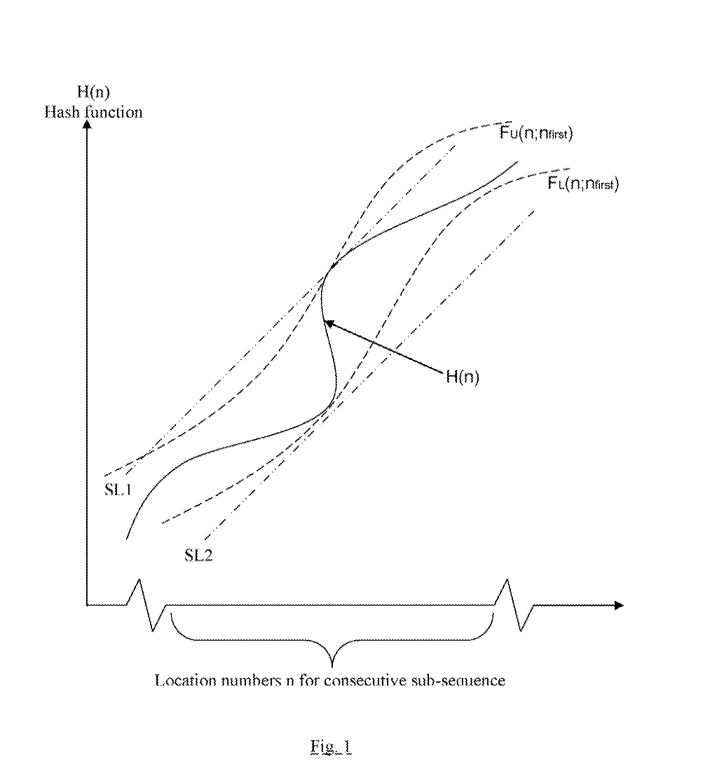

Generally, the hash function H(n) will be a monotonically increasing function of the location number n across all relevant Words in the collection, but may not be approximately linear. For each complete and consecutive set of occurrences of a specified Word in the collection, this portion of the graph {(n,H(n))}ₙ can be bounded by a pair of displaced lines, SL1 and SL2, lying above and below this portion of the graph, as indicated in FIG. 1, which define a region between the two displaced lines,

A_{L}(n−n_{first})+B_{L}≦H(n)}≦A_{U}(n−n_{first})+B_{U}, (1)

B_{L}≦H(n_{first})≦B_{U}, (2)

where A_{L}, A_{U}, B_{L}, B_{U} and n_{first} are parameters, preferably optimal parameters, that depend upon the specified Word and on the relative location of this Word within the sequence of relevant Words in the collection. The line slopes, A_{L} and A_{U}, will vary from one specified Word to the next, and it is not necessarily true that A_{L}=A_{U}. for a specified Word. The parameter n_{first} in Eq. (1) may identify the location number for the first occurrence of the specified Word in the collection.

More generally, the system provides or determines monotonically increasing bounding functions of location number n, F_{L}(n;n_{first}) and F_{U}(n;n_{first}), that define bounding relations,

F_{L}(n;n_{first})≦H(n)≦F_{U}(n;n_{first}) (3)

for the hash function, as illustrated in FIG. 1.

When a specified Word is to be searched, a particular occurrence of that Word (not necessarily the first occurrence) is identified, and the two bounding functions, F_{L}(n;n_{first}) and F_{U}(n;n_{first}), are used to bound, locate and identity all occurrences of the specified Word, in a total search time that is a fraction of the time that would be required for a conventional search for all occurrences of the specified Word throughout the collection. In one test of searching among about one billion words in a collection of documents, an average time required to identify all occurrences of a specified Word was about 100 msec.

One or more occurrences of a Word may be inserted, for example, where another document is added to the collection, by identifying the consecutive sub-sequences of Word pairs where that Word occurs and making the appropriate insertions in those sub-sequences. One or more occurrences of a Word may be deleted, for example, where a document or portion thereof is removed from the collection, by identifying the consecutive sub-sequences where that Word occurs and making the appropriate deletions in those sub-sequences. Thus, insertion and deletion, as a result of updating the collection, are straightforward.

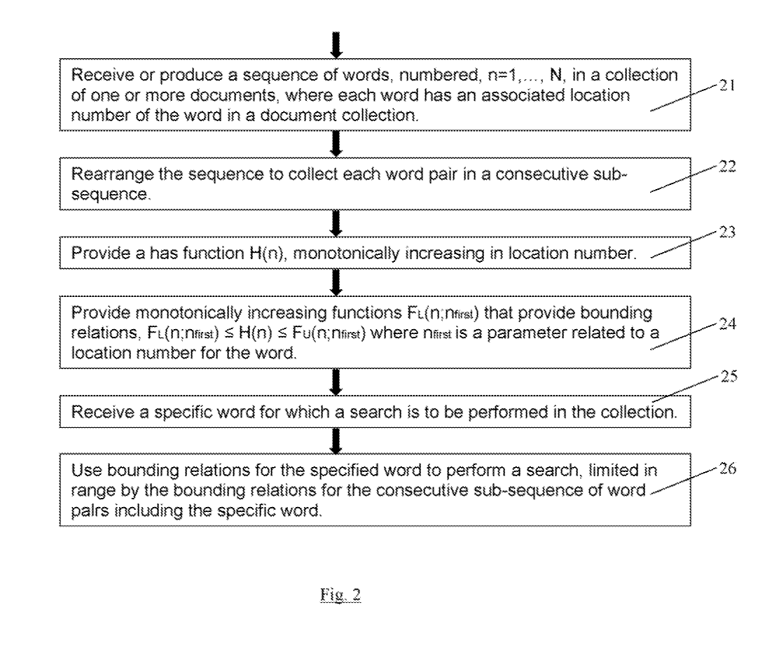

FIG. 2 is a flow chart of a procedure for practicing the first embodiment. In step 21, a computer or other system receives or otherwise provides a sequence of Words, numbered m=1, . . . , N in a collection of one or more documents, where each Word in the sequence has an associated location number or location index n indicating location of the associated Word in a document in the collection. The Word and the location number of this occurrence of the Word form a Word pair.

In step 22, the system rearranges the sequence to collect occurrences of each Word, and its associated location number(s), as a consecutive sub-sequence in a rearranged sequence. That is, the Word pairs for all occurrences of a Word in the collection are grouped together in a consecutive sub-sequence, preferably according to increasing location number n.

For each consecutive sub-sequence corresponding to occurrence of a given Word, the system, in step 23; provides a hash function H(n) that is monotonically increasing with increase of the location number n.

In step 24, the system provides monotonically increasing functions of n′, F_{L}(n;n_{first}) and F_{U}(n;n_{first}), corresponding to the given Word, for which the hash function H(n) within the consecutive sub-sequence satisfies bounding relations,

F_{L}(n;n_{first})≦H(n)≦F_{U}(n;n_{first}) (3)

where n_{first} is related to a location number in the consecutive sub-sequence. These bounding relations limit the range of location numbers n where a search for the specified Word is to be performed. Parameters, such as n_{first}, can vary from one consecutive sub-sequence to the next.

In step 25, the system receives a specified Word for which a search is to be performed in the collection of documents, and identifies the consecutive sub-sequence of Word pairs corresponding to the specified Word.

In step 26, the system uses the bounding relations for the specified Word to perform a search, limited in range by the bounding relations for the consecutive sub-sequence for the specified Word.

Examples of the functions Fₓ (x=L, U) are

$$\begin{matrix}{F}_{x} ( n ; {n}_{first} ) = {\sum }_{k = 0}^{K} {{c}_{x , k} ( n )}^{k + px} , & ( 4 A ) \\ {F}_{x} ( n ; {n}_{first} ; {n}_{first} ) = {c}_{x} exp \{ {d}_{x} ( n - {n}_{first} ) \} + {e}_{x} , & ( 4 B ) \\ {F}_{L} ( n ; {n}_{first} ) = {f}_{x} cosh ( n - {n}_{first} ) + {g}_{x} sinh ( n - {n}_{first} ) , & ( 4 C )\end{matrix}$$

where c_{x,k}, pₓ, cₓ, dₓ, fₓ and gₓ are parameters or coefficients.

The search for words and phrases extends to a search for strings of alphanumeric symbols (letters, numerals, punctuation marks, other characters) by replacing each “word” in a document by a corresponding ordered sequence of ASCII numbers, with each ASCII, number (e.g., 0-255) corresponding to one of the alphanumeric symbols. Punctuation and other special purpose symbols are optionally included. One can also extend a conventional ASCII library of symbols to an extended ASCII library that includes components of mathematical equations (e.g., +, −, ∫, ô/ôx, etc.) and other special purpose statements.

This system can be extended to include a Boolean search, in which occurrences of two or more specified Words, W1 and W2, are identified and a set of resulting occurrences of a Boolean operation, W1 B W2, are identified, where B is a Boolean operation, such as AND, OR, XOR or a similar operator. For example, the resulting occurrence sought may be “W1 AND W2 occur within N words of one another,” where N≦20. This “Boolean occurrence” of W1 and W2 can be identified as follows. Identify the separate occurrences of W1 and W2 and the corresponding sets, S1 and S2, of corresponding location numbers (indices n1 and n2, respectively). Let d(n1;n2) be the separation, measured in numbers of words (with the non-context words optionally removed and thus not considered) between a location number n1 in the set S1 and a location number n2 in the set S2.

W1 OR W2, The resulting set of Word occurrences is a simple union,

S(W1 OR W2)={S1}U{S2}, (5)

without reference to where the Words W1 and W2 occur relative to each other.

W1 AND W2, The resulting set of Word occurrences, with, a separation distance of no more than N words, is the joint set S(W1 AND W2;d≦N) of location numbers defined by

S(W1 AND W1;d≦N)={(n1,n2)|d(n1;n2)≦N}, (6)

which is a subset (possibly empty) of S1 and of S2.

W1 XOR W2. The resulting set of Word occurrences, with a separation distance of more than N words, is the joint set S(W1 AND W2;d>N) of location numbers defined by

S(W1 XOR W2;d>N)={(n1,n2)|d(n1,n2)>N for all n1} Ω {(n1′,n2′)|d(n1′;n2′)>N for all n2′}, (7)

which is a subset (possibly empty) of the union {S1}U{S2}. The set defined in Eq. (7) is an extension of an exclusive OR operation to an ordered sequence of words, with, a minimum separation distance of N+1 words.

Other Boolean occurrences can be defined or determined in a similar manner and are often expressible in terms of combinations of OR, AND and XOR, using DeMorgan's laws.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method for implementing a search of a database of information items, the method comprising providing a computer that is programmed:
to receive or provide a sequence of Words, numbered m=1, . . . , N in a collection of one or more documents, where each Word in the sequence has an associated location number indicating location of the associated Word in a document in the collection;
to rearrange the sequence to collect each occurrences of each Word, and its associated location index, as a consecutive sub-sequence in a rearranged sequence;
for each consecutive sub-sequence corresponding to occurrence of a given Word: to provide a hash function H(n) that is monotonically increasing with increase of the location number n, and to provide monotonically increasing functions F_{L}(n;n_{first}) and F_{U}(n;n_{first}) of n and a parameter n_{first} related to a location number in the consecutive sub-sequence, for which the hash function H(n′) within the consecutive sub-sequence satisfies a bounding relation,
F_{L}(n;n_{first})≦H(n)≦F_{U}(n;n_{first});
to receive a specified Word for which a search is to be performed in the collection of documents, and to identify a consecutive sub-sequence of Word pairs corresponding to the specified Word; and
to use the bounding relation for the specified Word to limit a search for at least one occurrence, and the associated location number, of the specified Word within the corresponding consecutive sub-sequence.

2. The method of claim 1, wherein said computer is further programmed to provide, as said bounding relation, the relation
A_{L}(n′−n_{first})+B_{L}≦H(n′)≦A_{U}(n′−n_{first})+B_{U},
where A_{L}, B_{L}, A_{U}, B_{U} are parameters corresponding to said given Word,

3. The method of claim 1, further comprising deleting, from said sequence of Words received or provided, all Words including at least one of the following classes of Words: articles, connectives, referents, possessives and prepositions.

4. The method of claim 1, wherein said computer is further programmed:
to implement addition of an added Word to said collection by (i) receiving or otherwise providing at least one location number corresponding to occurrence of the added Word, (ii) identifying or creating a consecutive sub-sequence in which the added Word appeal's or would appeal; (iii) adding the added Word and the corresponding location number to the identified or created consecutive sub-sequence.

5. The method of claim 1, wherein said computer is further programmed:
to implement deletion of a removed Word from said collection by (i) receiving or otherwise providing at least one location number corresponding to occurrence of the removed Word, (ii) identifying a consecutive sub-sequence in which the removed Word appears; (iii) removing the removed Word and the corresponding location number from the identified consecutive sub-sequence.

6. The method of claim 1, wherein said computer is further programmed:
to determine a Boolean occurrence, W1 OR W2, of specified Words W1 and W2 by: (1) determining a set S3 of all of said location numbers n1 for the Word W1; (2) determining a set S2 of all of said location numbers n2 for the Word W2; and (3) determining the set S(OR) of location numbers for the Boolean occurrence W1 OR W2 as the union {S1}U{S2}.

7. The method of claim L wherein said computer is further programmed:
to determine a Boolean occurrence, W1 AND W2, of specified Words W1 and W2 by: (1) determining a set S1 of all of said location numbers n1 for the Word W1; (2) determining a set S2 of all of said location numbers n2 for the Word W2; (3) determining the set S{W1 AND W2; d≦N) for the Boolean occurrence W1 AND W2 within N words of each other as
S(W1 AND W2;d≦N)={(n1,n2)|d(n1;n2)≦N}.

8. The method of claim 1, wherein said computer is further programmed:
to determine a Boolean occurrence, W1 XOR W2, of specified Words W1 and W2 by: (1) determining a set S1 of all of said location numbers n1 for the Word W1; (2) determining a set S2 of all of said location numbers n2 for the Word W2; (3) determining the set S(W1 XOR W2; d>N) for the Boolean occurrence W1 XOR W2 no closer than N+1. words from each other as
S(W1 XOR W2;d>N)={(n1,n2)|d(n1,n2)>N for all n1} Ω {(n1′, n2′)|d(n1′,n2′)>N for all n2′}.
